(19) United States
(12) Patent Application Publication
(10) Pub. No.: US 2010/0104077 A1
(43) Pub. Date: Apr. 29, 2010

(54) PUBLIC TELEPHONE FOR MANAGING AND PAYING SERVICES IN SITU AND OPERATION METHODS

(75) Inventors: Carlos Tejeda Elizondo, Monterrey (MX); Rafael Tajeda Elizondo, Monterrey (MX)

Correspondence Address: MICHAEL WINFIELD GOLTRY, 4000 N. CENTRAL AVENUE, SUITE 1220, PHOENIX, AZ, 85012, US

(73) Assignee: Grupo Empresarial R & C, S. A. DE C. V., Monterrey (MX)

(21) Appl. No.: 12/593,208

(22) PCT Filed: Mar. 26, 2008
(86) PCT No.: PCT/MX2008/000045

§ 371 Date: Sep. 25, 2009

(30) Foreign Application Priority Data
Mar. 26, 2007 (MX) MX/A/2007/003558

(51) Int. Cl. H04M 15/00

(52) U.S. Cl. 379/114.01

(57) ABSTRACT

A public telephone for managing and paying services in situ, the public telephone consists of a microphone and auricular, at least one input device for input of selective information for services management function and for general functioning of telephone calls, at least one output device for displaying selective information on the service management function and on the general telephone calls function, at least one communication interface faciliting the general telephone calls function, at least one communication interface with at least one services provider for faciliting the services management function; and at least one device for reception of payment of charges due to the service management function or the general telephone calls function. Operation methods for the public telephone as per the invention are described.

### TECHNICAL FIELD OF THE INVENTION

This invention is related in general to public telephones with fixed or wireless lines. In particular, but not limited, it refers to a public telephone for managing and paying services in situ and that may count on communication interfaces with at least one service provider.

### BACKGROUND OF THE INVENTION

At present, public telephones are used to establish local, national or international calls through prepay or postpay in situ of the total cost of the call. Public telephones generally count on means to realize phone calls, for example, a communication line with the fixed network or with the mobile network; and with means for charging and payment reception, for example, coin collectors, card payment readers, and prepay and postpay charging systems.

Additionally, the current public telephones allow to be controlled and supervised remotely from a supervision central in order to customize its operation mode, for example, performing maintenance of the telephone (alarms control, repairs, etc.), configuring the operation parameters (tariffs, numbering plan, etc.), statistic information management of the phone (number and type of calls, uses of payment means, collection, etc.), generation of reports, and teleloading of application programs.

The current public telephone limits the user and/or its owner to use it alone under the mode of telephone call as prepay or postpay of said phone, therefore the user and/or owner cannot use said public telephone as an interface with service providers that allows to manage the services offered by said providers, for example, purchase of airtime for mobile telephones, purchase of TV-programming, purchase of and unloading tones, purchase of and unloading music, purchase of and unloading videos, paying public services (electricity, water, drainage, CATV, Internet, etc.), paying banking services (credit cards), validation of credit cards, validation of electronic money, and control of product stocks.

As a result from the former, it is necessary to offer a public telephone that allows its users and/or owners to manage services in real time, establishing a communication interface with service providers and the payment in situ of related costs of said services.

### SUMMARY OF THE INVENTION

It is the objective of the present invention to provide a public telephone for managing and paying services in situ, the public telephone consists of a microphone and receiver, at least one input device for selective information input in order to manage the services and for the generic function of telephone calls, at least one output device to show the selective information of the management function of the services and the generic function of telephone calls, at least one communication interface to allow the generic function of telephone calls, at least one communication interface with at least one services provider to allow the function of services management, and at least one device for reception of payment of charges for the function of services management, or the generic function of telephone calls.

It is also the objective of this invention to offer a method for managing and paying services in situ through a public telephone, the method includes the steps of offering the user a selection option to realize the generic function of telephone calls or the function of services management; showing the user on an output device the selective information of at least one service that may be manager under the selection of the option of the function of services management; allowing the user to enter the selective information for the selected service to be managed on an input device; requiring the user payment of the corresponding amount for the service to be managed; receiving on a device the payment reception of the amount corresponding to the service to be managed; determining that the device of payment reception has received the total amount for the service to be managed; connecting, through the communicating interface, with a services provider of the service to be managed under the determination that the total predefined amount has been received for the service to be managed; sending the services provider at least a management message with the information selected by the user; determining if the service management has been accepted and performed by the services provider; and assuring the received amount on the payment reception device under the determination that the service management has been accepted and performed by the service provider.

It is the objective of this invention to offer a method for managing and paying services in situ through a public telephone, the method includes the steps of offering to the user a selection option to realize the generic function of telephone calls or the function of services management; showing to the user on an output device the selective information of at least one service that may be managed under the optional selection of the function of services management; connecting through a communication interface with a services provider of the service to be managed; allowing the user, on an input device, to enter the selective information for the selected service to be managed; interacting with the services provider to send at least one management message to the services provider with the user selected information; applying to the user for the payment of the corresponding amount for the service to be managed; receiving on a device the payment reception of the amount corresponding to the service to be managed; determining if the device of payment reception received the total amount for the service to be managed; determining if the service management has been accepted and performed by the service provider; and assuring the received amount on the payment reception device under the determination that the service management has been accepted and performed by the service provider.

### BRIEF DESCRIPTION OF THE FIGURES

The characteristic details of the present invention are described in the following paragraphs, together with the figures related to it, in order to define the invention, but not limiting the scope of it.

FIG. 1 illustrates the public telephone to manage and pay for service in situ according to the present invention.

FIG. 2 illustrates a communication system with public telephones according to the present invention.

FIGS. 3, 4 and 5 illustrate a block diagram of the embodiment of an operating method of the public telephone to manage and pay for service in situ according to the present invention.

### DETAILED DESCRIPTION OF THE INVENTION

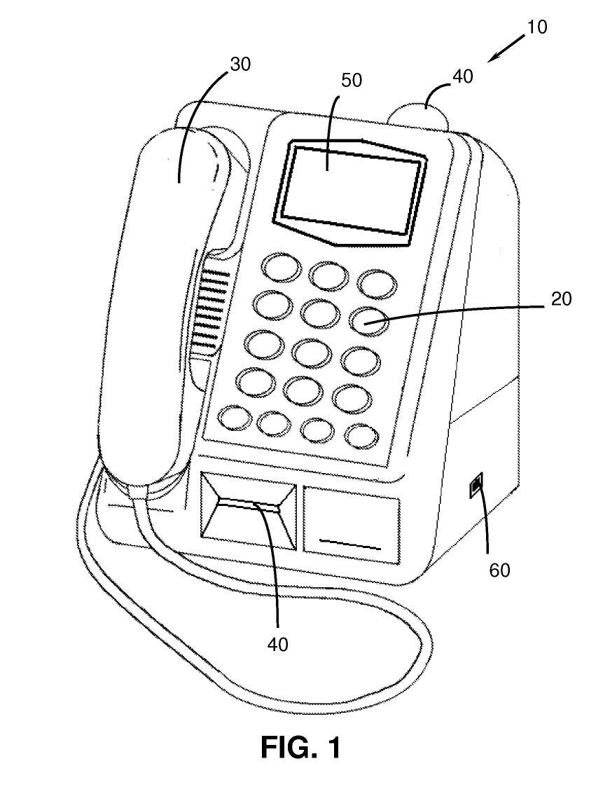

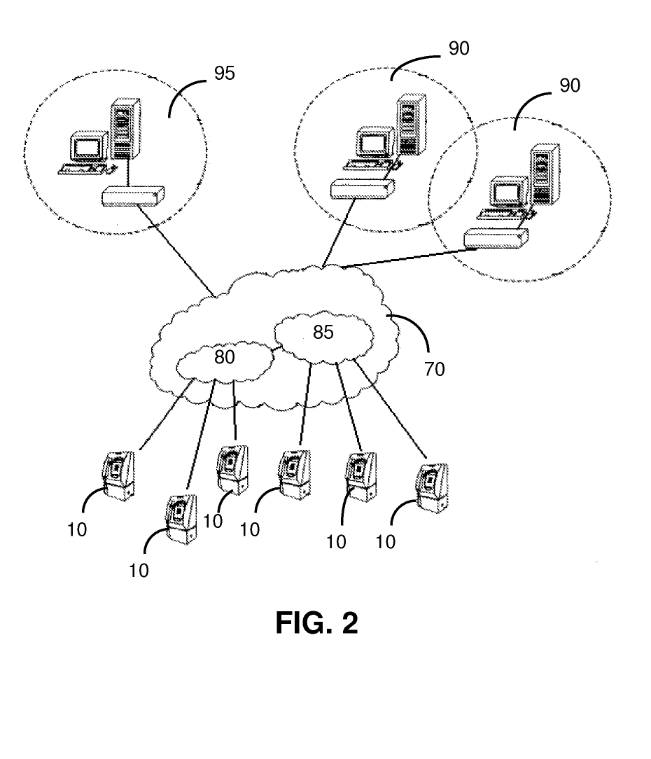

According to FIGS. 1 and 2 is illustrated a public telephone 10 where in its exterior there is one or more input devices 20, a microphone and auricular 30, one or various payment reception devices payment 40, one or more output devices 50, and alternatively at least one local communication port 60 towards an external device (not shown); whereas in the interior there is a processing unit and at least one programmable memory in the form of one or various printed circuit boards (not shown) that regulate the operation of the public telephone and one of various printed circuit boards (not shown) that serve as the communication interface of voice and data towards at least one communication network 70 of fixed telephone line 80 or wireless telephone 85, towards at least a services provider 90 and towards a supervision centre 95.

Input device 20 is used as a means for the input of selective information that may be selected by the user in order to operate the telephone to serve as services management or for the generic function of telephone calls. Among the input devices 20 that may be used, there are, for example, a keyboard with or without keys for a specific function, a tactile screen, and combinations thereof.

Output device 50 shows the user the status or current function that the telephone is operating in, as well as the selective information as a menu or messages of the services to be managed, and of the generic function of telephone calls. Among the output devices 50 that may be used, there are, for example, a crystal liquid display or inclusive the microphone and auricular themselves 30.

The payment reception devices 40 may be formed by, for example, coins input and output devices, notes input and output devices, card readers' devices, prepay and postpay devices, and combinations thereof that represent the payment reception means of public telephone 10, as well of the charges for the generic function of calls or the managed services.

The input and output devices of coins and notes allow the user to realize payment of the telephone call or the managed service, through coins, cards, tokens and notes that are validated in the interior of the public telephone 10 and that once the service has been provided are assured, that is, form part of the collection box or those that exceed the amount charged are returned through the output device of coins of notes.

The card reading devices with a technology widely known in public telephony, allow the user to pay for the service of telephone calls or services management through the different types of cards, for example, telephone cards, cards with points, or credit or debit cards from the bank.

The programmable memory (not shown) is used as a means to store information related to the generic function of calls, as well as to the services to be managed. Stored information may be predefined or updated in real time. It should be mentioned that in case the services management function is performed with a services provider 90 that uses some device of Interactive Voice Response (IVR) to perform the interaction with the user through the public telephone 10, then it is not necessary to store any information.

Among the services that may be managed with services providers 90 through the public telephone 10 we find, for example, purchase of airtime for wireless phones, purchase of TV programming, purchase and downloading of tones, purchase and downloading of music, purchase and downloading of videos, purchase and downloading of information, payment of public services, payment of banking services, and combinations thereof.

The communication interface of the public telephone 10, with access to services providers 90 can be voice technology or data packages that are used on the fixed telephone lines or wireless networks, for example, Double Tone Multi-Frequency (DTMF), Integrated Services Digital Network (ISDN), Digital Subscriber Line (DSL), Asymmetric Digital Subscriber Line (ADSL), Symmetric Digital Subscriber Line (SDSL), ISDN Digital Subscriber Line (IDSL), High Bit-Rate Digital Subscriber Line (HDSL), Single High Bit-Rate Digital Subscriber Line (SHDSL), Very High Bit-Rate Digital Subscriber Line (VDSL), Global System for Mobile Communications (GSM), General Packet Radio Service (GPRS), Enhanced Data for GSM Evolution (EDGE), Code Division Multiple Access 2000 (CDMA2000), Universal Mobile Telecommunications System (UTMS), Freedom of Mobile Multimedia Access (FOMA), Wideband Code Division Multiple Access (WCDMA), Time Division Synchronous Code Division Multiple Access (TD-SCDMA), High Speed Downlink Packet Access (HSDPA), High Speed Uplink Packet Access (HSUPA), and combinations thereof.

The public telephone 10 sends and receives management messages according to a communication protocol established with the services providers 90 in order to manage the required service. These management messages are sent or received through the communication interface with the service provider and are structured in codified messages in DTMF, communication messages of fixed and wireless telephony, for example, text messages, messages of Instant Message (IM), messages from Short Message Service (SMS), messages from the Multimedia Message System (MMS), messages from the Unstructured Supplementary Services Data (USSD), messages in XML or HTTP format, and combinations thereof that may be sent or received through the communication interface of data of the public telephone 10.

In an alternative embodiment, the local communication port 60 has a least one external device (not shown), for example, a portable memory, a terminal, etc. that may be a wired or wireless interface, for example, a USB port, an RS-232 port, an RS-485 port, an Ethernet port, a parallel LPT port, a TCP-IP interface port, a Firewire interface, a Bluetooth port, an infrared Direct Access (IrDA) interface, a Radio Frequency Identification (RFiD) interface, a Hiperlan-2 interface, a HomeRF interface, an X.10 interface, a PS-2 interface, a Wireless Fidelity (Wi-Fi) interface, an IEEE 802.11b interface, an IEEE 802.11 interface, an IEEE 802 interface with normalized protocols or communication proprietary, and combinations thereof.

Alternatively, the current public telephone 10 may be controlled and supervised remotely from a least one remote centre 95, in order to customize its operation mode, for example, performing maintenance of the telephone (alarms control, repairs, etc.), configuring its operation parameters (tariffs, numbering plan, etc.), statistic information management of the phone (number and type of calls, uses of payment means, collection, etc.), generation of reports and teleloading of application programs.

In an alternative embodiment, the public telephone 10 can have on a printer to issue a payment receipt to the user for the managed service.

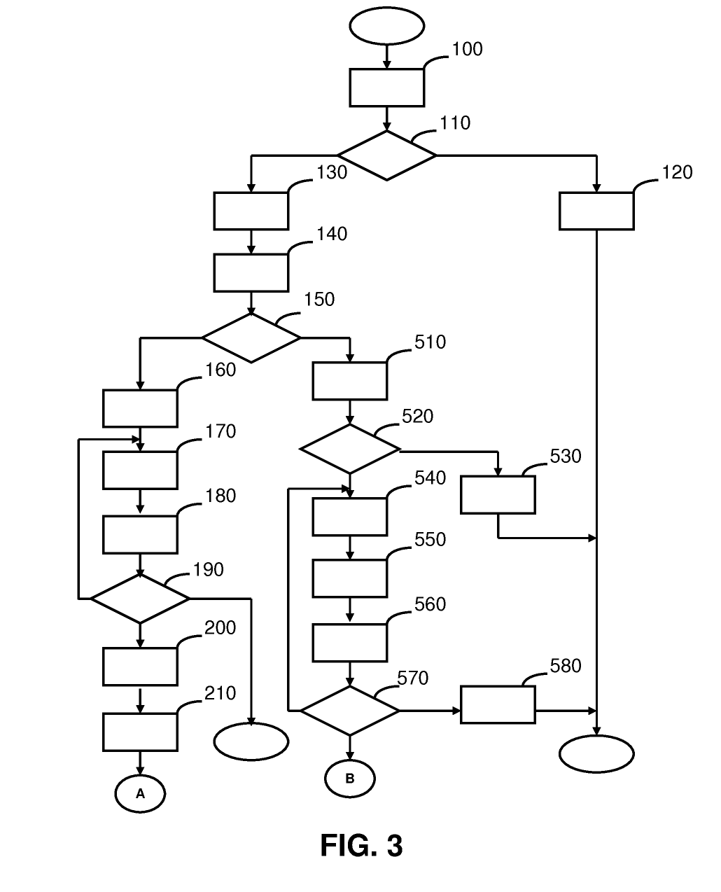

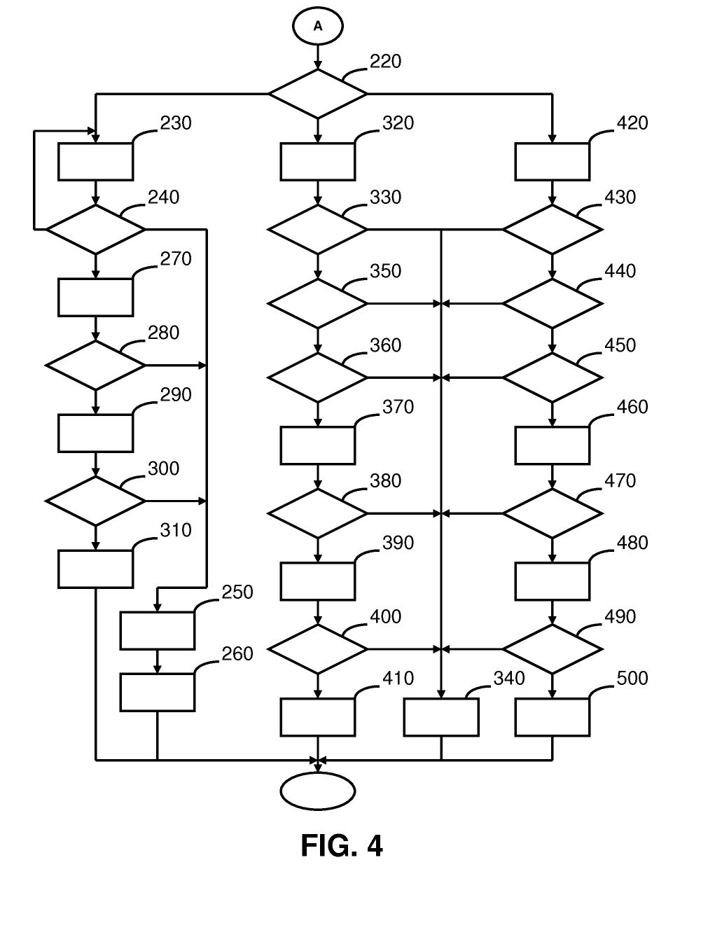

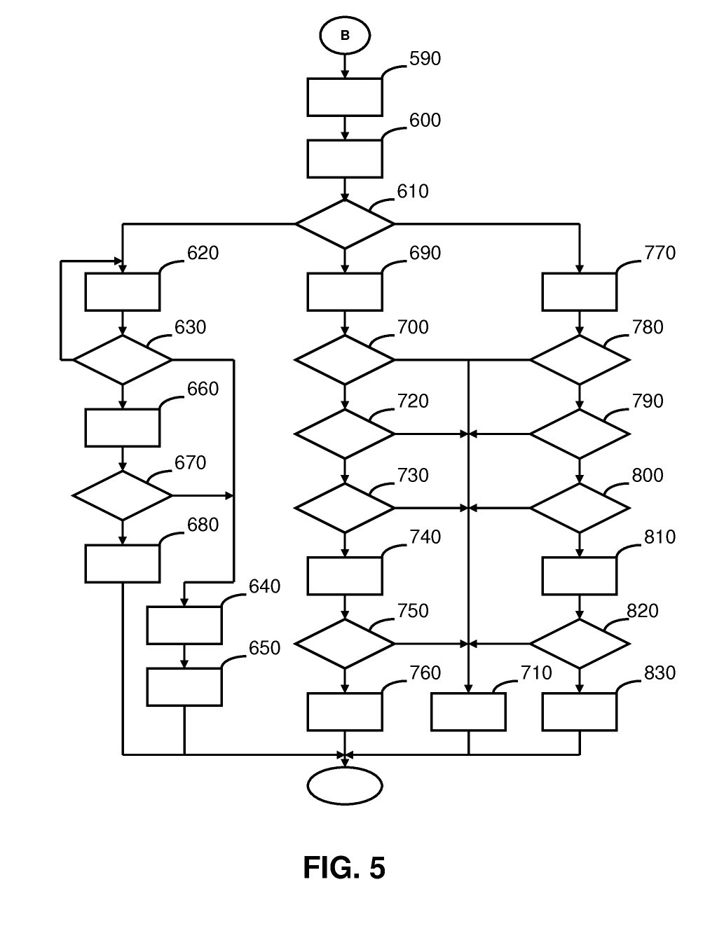

Turn now to FIGS. 3, 4 and 5, an embodiment is shown of an operating method of the public telephone according to the present invention. The method initiates in step 100 where the public telephone, in its state on hold, shows the selection menu through its output device, for example, the screen, indicating the function modes of the public telephone that may be selected by the user through the input device, for example, and one or some particular keys of the keyboard. The available function modes for this embodiment are the generic function of telephone calls or the services management function.

In step 110, the public telephone detects the function mode option that was selected by the user. In case the user selects the option of the generic function of telephone calls or the auricular is detected to be off hold, the public telephone proceeds to operate according to the generic function of calls, known really in step 120. On the other hand, that is, the public telephone detects that the option of the services management function mode was selected by the user, then, step 130, shows on the output device (display) selective information on the different services options that may be managed through the public telephone, for example, purchase of airtime for mobile phones, purchase of TV programming, purchase and downloading of tones, purchase and downloading of music, purchase and downloading of videos, purchase and downloading of information, purchase of public services, purchase of banking services.

Once the selective information of the different services options that may be managed through the public telephone is shown, step 140 proceeds to detect the selected service option by the user through the input device, for example, when the user selects purchase of airtime. In step 150 it is determined that if the user selected option corresponds to an option which selective information to form the management information with the services provider is predefined in the programmable memory of the public telephone, that is, the user can only select selective information out of a menu of predefined options on the public telephone; or if the selected service option requires interaction with the services provider to form the management information, that is, the server of the services provider interacts with the user providing selective information of the service to be managed through the public telephone.

In case the selected service to be managed corresponds to a service which selected information to form the information is predefined in the programmable memory of the public telephone, step 160 proceeds to extract from the programmable memory the selective information corresponding to the selected service, which, in step 170 is shown to the user through the output device so that the user may select it through the input device, for example, the user selects from the menu the telephone company menu from which he/she wants to purchase airtime and the amount of airtime to be purchased. In step 180, the information selected by the user is temporarily stored on a programmable memory to be used as management information from the services provider. Next, in step 190, the public telephone determines if the information selected by the user was completed to proceed to step 200, or if any information is missing that should be selected so that returning to step 170 is required, or if time for selection of information has finished so that the management function is terminated, returning to the initial status.

In step 200 the user is prompted to pay the required amount for the service showing a message therefore through the output device, the information on the amount to be paid is extracted from the programmable memory. Next, in step 210, the user is indicated to select the type of payment, for example, cash, by telephone card, by points, or with a credit or debit card. In step 220 the option of the type of payment selected by the user is detected through the input device. In case the user selects the option of paying in cash, then in step 230, the public telephone proceeds to receive the amount to be paid for the service through the input and output device of coins or notes. Later in step 240, the public telephone determines if the input of the total amount of payment on behalf of the user was completed to proceed to step 270, or if any amount for payment is missing so that it returns to step 230, or if the time has finished for the input of the total payment amount so that is proceeded, in step 250, to inform the user on such situation, and later to proceed to return to the user, in step 260, the total amount of money that has been collected in step 230, therefore proceeding to terminate the management function, and returning to the initial status.

Once the total amount for payment has been received in step 270, the public telephone proceeds to connect with the services provider suited for the option of the service selected by the user, the connection is realized through the communication interface with the services provider and according to the communication protocol established between the services provider and the public telephone. Then, in step 280, it is determined if the connection was established, but if not so, in step 250, the user is informed on such situation, and later, in step 260, the total amount of money that had been collected in step 230 is returned to the user, then it is proceeded to terminate the management function, returning to the initial status.

In step 290, in case the connection with the services provider was established, the public telephone proceeds to build and send at least one management message to the services provider, containing the management information selected by the user and that was stored in the programmable memory in step 180, the construction and sending of the management message or messages is performed according to the communication protocol established by the services provider and the public telephone, and they are sent in communication messages as described above.

Once the management messages are built and sent, the public telephone, in step 300 proceeds to determine if the service management was accepted and performed by the service provider in order to proceed later on, in step 310, in assuring the total collected amount in step 230, indicating the user that the management service was successful; however, on the other hand, that is, if the service management was not accepted and performed by the services provider, in step 250, it is proceeded to inform the user on such situation, later proceeding to return to the user, in step 260, the total amount of money that had been collected in step 230, therefore proceeding to terminate the management function returning to the initial status and closing the connection with the services provider.

Returning to step 220, in case the user is detected to have selected the type of payment through a telephone card or points, in step 320, the user is prompted to insert a card. Next, in step 330, the public telephone proceeds to detect if the user inserted a card in the card reading device, on the other hand, the public telephone proceeds to inform the user on such situation, in step 340, later to proceed to terminate the management function, returning to the initial status.

If a card was inserted, then the card is validated in step 350. In case the card is invalidated, the user is informed on such situation in step 340, later to proceed to terminate the management function, returning to the initial status. But in case the card is validated, then, in step 360, the public telephone proceeds to check if the card inserted has sufficient credit or points to collect the amount to be paid for the service. In case a card was inserted that does not have sufficient credit or points, the user is informed on such situation in step 340, later to proceed to terminate the management function, returning to the initial status.

Once it is established that the card counts on sufficient credit or points for payment of the service, in step 370, the public telephone proceeds to connect with the services provider suited for the option of the service selected by the user, the connection is realized through the communication interface with the services provider and according to the communication protocol established between the services provider and the public telephone. Later, in step 380 it is determined if the connection was established, but otherwise, it is proceeded to inform the user on such situation in step 340, next to proceed to terminate the management function, returning to the initial status.

In step 390, in case the connection with the services provider was established, the public telephone proceeds to build and send at least one management message to the services provider, containing the management information selected by the user and that was stored in the programmable memory in step 180, the construction and sending of the management message or messages is performed according to the communication protocol established by the services provider and the public telephone, and they are sent in communication messages as described above.

Once the management messages are built and sent, the public telephone, in step 400 proceeds to determine if the service management was accepted and performed by the service provider in order to proceed later on, in step 410, in assuring the payment diminishing the payment amount from the credit or points of the card, indicating the user that the management service was successful; otherwise, that is, if the service management was not accepted and performed by the services provider, it is proceeded to inform the user on such situation, in step 340, later proceeding to terminate the management function returning to the initial status and closing the connection with the services provider.

Returning to step 220, in case the user is detected to have selected the type of payment through a telephone card or points, in step 420, the user is prompted to insert a card. Next, in step 430, the public telephone proceeds to detect if the user inserted a card in the card reading device, otherwise, the public telephone proceeds to inform the user on such situation, in step 340, later to proceed to terminate the management function, returning to the initial status.

If a card was inserted, then the public telephone proceeds to connect to a banking services provider to validate the card in step 440. In case the card is invalidated, the user is informed on such situation in step 340, later to proceed to terminate the management function, returning to the initial status. But in case the card is valid, then, in step 460, the public telephone proceeds to check as determined by the banking services provider if the card inserted has sufficient credit to collect the amount to be paid for the service. In case the card does not have sufficient credit or points, the user is informed on such situation in step 340, later to proceed to terminate the management function, returning to the initial status.

Once it is checked and determined that the card counts on sufficient credit for payment of the service, in step 470, the public telephone proceeds to connect with the server of the services provider suited for the option of the service selected by the user, the connection is realized through the communication interface with the services provider and according to the communication protocol established between the services provider and the public telephone. Later, in step 480 it is determined if the connection was established, but otherwise, it is proceeded to inform the user on such situation in step 340, and next to proceed to terminate the management function, returning to the initial status.

In step 490, in case the connection with the services provider was established, the public telephone proceeds to build and send at least one management message to the services provider, containing the management information selected by the user and that was stored in the programmable memory in step 180, the construction and sending of the management message or messages is performed according to the communication protocol established between the services provider and the public telephone, and they are sent in communication messages as described above.

Once the management messages are built and sent, the public telephone, in step 500 proceeds to determine if the service management was accepted and performed by the service provider in order to proceed later on, in step 510, in assuring the payment indicating the banking services provider that a charge be made on account of the credit card, indicating the user that the management service was successful and alternatively printing a receipt for the service; otherwise, that is, if the service management was not accepted and performed by the services provider, then it is proceeded to inform the user on such situation, in step 340, later proceeding to terminate the management function returning to the initial status and closing the connection with the services provider.

Returning to step 150, in case the selected service option requires interaction with the services provider to form the management information, that is, the server of the services provider interacts with the user providing selective information on the service to be managed through the public telephone, in step 510 it is proceeded to connect with the services provider suited for the option of the selected service by the user, the connection is performed through the communication interface with the services provider and according to the communication protocol established between the services provider and the public telephone. Later, in step 520 it is determined if the connection was established, but otherwise, it is proceeded to inform the user on such situation in step 530, and next to proceed to terminate the management function, returning to the initial status.

In step 540, in case the connection with the services provider was established, the public telephone proceeds to interact with the services provider according to the protocol established between both to show the user, in step 550, the selective information corresponding to the selected service through the output device so that the user selects it through the input device. In step 560, the information selected by the user is sent as management messages to the services provider. Next, in step 570, the public telephone determines if the information selected by the user was completed to proceed to step 580, or if any information is missing that should be selected so that returning to step 540 is required, or if time for selection of information has finished, then in step 580, the user is informed on such situation, later to proceed to terminate so that the management function, returning to the initial status and close the connection with the services provider.

In step 590 the user is prompted to pay the required amount for the service showing a message therefore through the output device, the information on the amount to be paid is received from the services provider. Next, in step 600, the user is indicated to select the type of payment, for example, cash, by telephone card, by points, or with a credit or debit card. In step 610 the option of the type of payment selected by the user is detected through the input device. In case the user selects the option of paying in cash, then in step 620, the public telephone proceeds to receive the amount to be paid for the service through the input and output device of coins or notes. Later in step 630, the public telephone determines if the input of the total amount of payment on behalf of the user was completed to proceed to step 660, or if any amount for payment is missing so that it returns to step 620, or if the time has finished for the input of the total payment amount so that is proceeded, in step 640, to inform the user on such situation, and later to proceed to return to the user, in step 650, the total amount of money that has been collected in step 620, therefore proceeding to terminate the management function, and returning to the initial status, and closing the connection with the services provider.

Once the total amount of payment received, in step 660, the public telephone proceeds to build and send at least one management message to the services provider, indicating the services provider that payment was completed. Once, in step 670, it is proceeded to determine if the service management was accepted and performed by the service provider, later to proceed, in step 680, assuring the total collected amount in step 620, indicating the user that the management service was successful; otherwise, that is, if the service management was not accepted and performed by the services provider, in step 640, it is proceeded to inform the user on such situation, later proceeding to return to the user, in step 650, the total amount of money that had been collected in step 620, therefore proceeding to terminate the management function returning to the initial status and closing the connection with the services provider.

Returning to step 610, in case the user is detected to have selected the type of payment through a telephone card or points, in step 690, the user is prompted to insert a card. Next, in step 700, the public telephone proceeds to detect if the user inserted a card in the card reading device, otherwise, the public telephone proceeds to inform the user on such situation, in step 710, later to proceed to terminate the management function, returning to the initial status and closing the connection with the services provider.

If a card was inserted, then the card is validated in step 720. In case the card is invalidated, the user is informed on such situation in step 710, later to proceed to terminate the management function, returning to the initial status and closing the connection with the services provider. But in case the card is validated, then, in step 730, the public telephone proceeds to check if the card inserted has sufficient credit or points to collect the amount to be paid for the service. In case the card does not have sufficient credit or points, the user is informed on such situation in step 710, later to proceed to terminate the management function, returning to the initial status and closing the connection with the services provider.

Once the total amount of payment received and determined that the card has sufficient credit or points for payment of the service, in step 740, the public telephone proceeds to build and send at least one management message to the services provider, indicating the services provider that payment was completed. Once, in step 750, the public telephone proceeds to determine if the service management was accepted and performed by the service provider in order to proceed later on, in step 760, in assuring the payment diminishing the payment amount from the credit or points of the card, indicating the user that the management service was successful; otherwise, that is, if the service management was not accepted and performed by the services provider, it is proceeded to inform the user on such situation, in step 710, later proceeding terminate the management function returning to the initial status and closing the connection with the services provider.

Returning to step 610, in case the user is detected to have selected the type of payment through a telephone card or points, in step 770, the user is prompted to insert a card. Next, in step 780, the public telephone proceeds to detect if the user inserted a card in the card reading device, otherwise, the public telephone proceeds to inform the user on such situation, in step 710, later to proceed to terminate the management function, returning to the initial status and closing the connection with the services provider.

If a card was inserted, then the public telephone proceeds to connect to a banking services provider to validate the card in step 790. In case the card is invalidated, the user is informed on such situation in step 710, later to proceed to terminate the management function, returning to the initial status and closing the connection with the services provider. But in case the card is valid, then, in step 800, the public telephone proceeds to check as determined by the banking services provider if the card inserted has sufficient credit to collect the amount to be paid for the service. In case the card does not have sufficient credit or points, the user is informed on such situation in step 710, later to proceed to terminate the management function, returning to the initial status and closing the connection with the services provider.

Once perceived and determined that the card has sufficient credit or points for payment of the service, in step 810, the public telephone proceeds to build and send at least one management message to the services provider, indicating the services provider that payment was completed. Once the public telephone, in step 820 proceeds to determine if the service management was accepted and performed by the service provider in order to proceed later on, in step 830, in assuring the payment indicating the banking services provider that a charge be made on account of the credit card, indicating the user that the management service was successful and alternatively printing a receipt for the service; otherwise, that is, if the service management was not accepted and performed by the services provider, then it is proceeded to inform the user on such situation, in step 710, later proceeding to terminate the management function returning to the initial status and closing the connection with the services provider.

Based on the embodiments described above, modifications to said embodiments are considered, as well as the alternative embodiments will be considered evident for an expert in the art of the technique under the present description. Therefore, it is considered that the claims cover said modifications and alternatives that are within the scope of the present invention or its equivalents.

1. A public telephone for managing and paying for services in situ, the public telephone is characterized by comprising:
a microphone and auricular;
at least an input device for the input of selective information for the services management function and the generic function of telephone calls;
at least an output device to show selective information of said services management function and of said generic function of telephone calls;
at least a communication interface to allow said generic function of telephone calls;
at least a communication interface with at least one services provider to allow said services management function; and
at least a payment reception device of the charges for said services management function or of said generic function of telephone calls.

2. The public telephone of claim 1, wherein said services management function includes services selected from a group consisting of purchase of airtime for wireless phones, purchase of TV programming, purchase and downloading of tones, purchase and downloading of music, purchase and downloading of videos, purchase and downloading of information, payment of public services, payment of banking services, and combinations thereof.

3. The public telephone of claim 1, wherein said public telephone is a fixed telephone line or a wireless phone.

4. The public telephone of claim 1, wherein said input device is a keyboard or a tactile display.

5. The public telephone of claim 1, wherein output device is a display or said microphone and auricular.

6. The public telephone of claim 1, wherein said communication interface with at least one services providers is technology selected from a group consisting of Double Tone Multi-Frequency (DTMF), Integrated Services Digital Network (ISDN), Digital Subscriber Line (DSL), Asymmetric Digital Subscriber Line (ADSL), Symmetric Digital Subscriber Line (SDSL), ISDN Digital Subscriber Line (IDSL), High Bit-Rate Digital Subscriber Line (HDSL), Single High Bit-Rate Digital Subscriber Line (SHDSL), Very High Bit-Rate Digital Subscriber Line (VDSL), Global System for Mobile Communications (GSM), General Packet Radio Service (GPRS), Enhanced Data for GSM Evolution (EDGE), Code Division Multiple Access (CDMA2000), Universal Mobile Telecommunications System (UTMS), Freedom of Mobile Multimedia Access (FOMA), Wideband Code Division Multiple Access (WCDMA), Time Division Synchronous Code Division Multiple Access (TD-SCDMA), High Speed Downlink Packet Access (HSDPA), High Speed Uplink Packet Access (HSUPA), and combinations thereof.

7. The public telephone of claim 1, wherein said public telephone further includes a processing unit that is able to send and receive management messages towards and from said services providers through said communication interface with at least one services provider.

8. The public telephone of claim 7, wherein said management messages sent or received are contained in communication messages of a fixed telephone line or wireless telephone selected from a group consisting of codified messages in DTMF, text messages, messages of Instant Message (IM), messages from Short Message Service (SMS), messages from the Multimedia Message System (MMS), messages from the Unstructured Supplementary Services Data (USSD), messages in XML or HTTP, and combinations thereof.

9. The public telephone of claim 1, wherein said payment reception devices are selected from a group consisting of input and output devices of coins, input and output devices of notes, card readers devices, prepay and postpay devices, and combinations thereof.

10. The public telephone of claim 1, wherein said public telephone further includes at least one local communication port selected from a group consisting of a USB port, an RS-232 port, an RS-485 port, an Ethernet port, a parallel LPT port, a TCP-IP interface port, a Firewire interface, a Bluetooth port, an infrared Direct Access (IrDA) interface, a Radio Frequency Identification (RFiD) interface, a Hiperlan-2 interface, a HomeRF interface, an X.10 interface, a PS-2 interface, a Wireless Fidelity (Wi-Fi) interface, an IEEE 802.11b interface, an IEEE 802.11 interface, an IEEE 802 interface with normalized protocols or communication proprietary, and combinations thereof.

11. The public telephone of claim 1, wherein said public telephone further includes at least one communication interface with access to at least one remote exchange for supervision, control, programming, and reporting of statistics of said public telephone.

12. The public telephone of claim 1, wherein said public telephone includes at least one programmable memory that stores information of said services management function and of said function of telephone calls.

13. The public telephone of claim 1, wherein said public telephone further includes at least one printer to output a receipt for payment of the service managed by the services management function.

14. A method for managing and paying for services in situ through a public telephone, the method is characterized by comprising the steps of:
offering to a user a selection option for performing the generic function of telephone calls or the services management function;
showing to said user, on an output device, selective information of at least one service that may be managed under the selection of said services management function;
allowing to said user, on an input device, the input of selective information for said service selected to be managed;
requiring to said user the payment amount corresponding to said service to be managed;
receiving on a payment reception device the amount corresponding to said service to be managed;
determining whether said payment reception device received the total amount corresponding to said service to be managed;
connecting, through a communication interface, to a services provider of the service to be managed, under the determination that the predefined total amount was received for said service to be managed;
sending to said services provider at least one management message with the information selected by the user;
determining if the service management has been accepted and performed by said service provider; and
assuring said amount received through the payment reception device under the determination that said service management has been accepted and performed by said service provider.

15. The method of claim 14, wherein said services management function includes services selected from a group consisting of purchase of airtime for wireless phones, purchase of TV programming, purchase and downloading of tones, purchase and downloading of music, purchase and downloading of videos, purchase and downloading of information, payment of public services, payment of banking services, and combinations thereof.

16. The method of claim 14, wherein said public telephone is a fixed telephone line or a wireless phone.

17. The method of claim 14, wherein said input device is a keyboard or a tactile display.

18. The method of claim 14, wherein said output device is a display or said microphone and auricular.

19. The method of claim 14, wherein said communication interface to connect with said services provider is technology selected of a group consisting of Double Tone Multi-Frequency (DTMF), Integrated Services Digital Network (ISDN), Digital Subscriber Line (DSL), Asymmetric Digital Subscriber Line (ADSL), Symmetric Digital Subscriber Line (SDSL), ISDN Digital Subscriber Line (IDSL), High Bit-Rate Digital Subscriber Line (HDSL), Single High Bit-Rate Digital Subscriber Line (SHDSL), Very High Bit-Rate Digital Subscriber Line (VDSL), Global System for Mobile Communications (GSM), General Packet Radio Service (GPRS), Enhanced Data for GSM Evolution (EDGE), Code Division Multiple Access (CDMA2000), Universal Mobile Telecommunications System (UTMS), Freedom of Mobile Multimedia Access (FOMA), Wideband Code Division Multiple Access (WCDMA), Time Division Synchronous Code Division Multiple Access (TD-SCDMA), High Speed Downlink Packet Access (HSDPA), High Speed Uplink Packet Access (HSUPA), and combinations thereof.

20. The method of claim 14, wherein said management messages are contained in communication messages of a fixed telephone line or wireless telephone selected from a group consisting of codified messages in DTMF, text messages, messages of Instant Message (IM), messages from Short Message Service (SMS), messages from the Multimedia Message System (MMS), messages from the Unstructured Supplementary Services Data (USSD), messages in XML or HTTP, and combinations thereof.

21. The method of claim 14, wherein said payment reception device is selected from a group consisting of input and output devices of coins, input and output devices of notes, card readers devices, prepay and postpay devices, and combinations thereof.

22. The method of claim 14, wherein said step of sending at least one management message to said services provider with the information selected by the user, includes the step of building said management message according to a protocol established between said public telephone and said services provider.

23. The method of claim 14, wherein further includes the step of issuing a receipt for payment of the service managed.

24. A method for managing and paying for services in situ through a public telephone, the method is characterized by comprising the steps of:
offering to a user a selection option for performing the generic function of telephone calls or the services management function;
showing to said user, on an output device, selective information of at least one service that may be managed under the selection of said services management function;
connecting through a communication interface with a services provider of the service to be managed;
allowing to said user, on an input device, the input of selective information for said service selected to be managed;
interacting with said services provider while sending to said services provider at least one management message with the information selected by the user;
requiring said user the payment amount corresponding to said service to be managed;
receiving on a payment reception device the amount corresponding to said service to be managed;
determining whether said payment reception device received the total amount corresponding to said service to be managed;
determining if the service management has been accepted and performed by said service provider; and
assuring said amount received through the payment reception device under the determination that said service management has been accepted and performed by said service provider.

25. The method of claim 24, wherein said services management function includes services selected from a group consisting of purchase of airtime for wireless phones, purchase of TV programming, purchase and downloading of tones, purchase and downloading of music, purchase and downloading of videos, purchase and downloading of information, payment of public services, payment of banking services, and combinations thereof.

26. The method of claim 24, wherein said public telephone is a fixed telephone line or a wireless phone.

27. The method of claim 24, wherein said input device is a keyboard or a tactile display.

28. The method of claim 24, wherein said output device is a display or said microphone and auricular.

29. The method of claim 24, wherein said communication interface to connect with said services provider is technology selected of a group consisting of Double Tone Multi-Frequency (DTMF), Integrated Services Digital Network (ISDN), Digital Subscriber Line (DSL), Asymmetric Digital Subscriber Line (ADSL), Symmetric Digital Subscriber Line (SDSL), ISDN Digital Subscriber Line (IDSL), High Bit-Rate Digital Subscriber Line (HDSL), Single High Bit-Rate Digital Subscriber Line (SHDSL), Very High Bit-Rate Digital Subscriber Line (VDSL), Global System for Mobile Communications (GSM), General Packet Radio Service (GPRS), Enhanced Data for GSM Evolution (EDGE), Code Division Multiple Access (CDMA2000), Universal Mobile Telecommunications System (UTMS), Freedom of Mobile Multimedia Access (FOMA), Wideband Code Division Multiple Access (WCDMA), Time Division Synchronous Code Division Multiple Access (TD-SCDMA), High Speed Downlink Packet Access (HSDPA), High Speed Uplink Packet Access (HSUPA), and combinations thereof.

30. The method of claim 24, wherein said management messages are contained in communication messages of a fixed telephone line or wireless telephone selected from a group consisting of codified messages in DTMF, text messages, messages of Instant Message (IM), messages from Short Message Service (SMS), messages from the Multimedia Message System (MMS), messages from the Unstructured Supplementary Services Data (USSD), messages in XML or HTTP, and combinations thereof.

31. The method of claim 24, wherein said payment reception device is selected from a group consisting of input and output devices of coins, input and output devices of notes, card readers devices, prepay and postpay devices, and combinations thereof.

32. The method of claim 24, wherein said step of interacting with said services provider while sending to said services provider at least one management message with the information selected by the user, includes the step of building said management message according to a protocol established between said public telephone and said services provider.

33. The method of claim 24, wherein further includes the step of issuing a receipt for payment of the service managed.
